(19) United States
(12) Patent Application Publication
(10) Pub. No.: US 2017/0019147 A1
(43) Pub. Date: Jan. 19, 2017

(54) Capture and Analysis of Transient Events in Hybrid Fiber-Coaxial (HFC) Networks

(71) Applicant: Futurewei Technologies, Inc., Plano, TX (US)

(72) Inventors: Karl E. Moerder, Poway, CA (US); John L. Moran, III, Millville, MA (US); Marc L. Morrissette, Plainville, MA (US)

(21) Appl. No.: 15/043,042

(22) Filed: Feb. 12, 2016

Related U.S. Application Data
(60) Provisional application No. 62/194,002, filed on Jul. 17, 2015.

(51) Int. Cl. H04B 3/46; H04B 10/077

(52) U.S. Cl. CPC H04B 3/46; H04B 10/0773

(57) ABSTRACT

A coaxial cable remote diagnostic management tool (RDMT) comprises a receiver configured to receive a first signal, wherein the first signal is a time domain signal; and receive an instruction to analyze the first signal; and a processor coupled to the receiver and configured to: generate a trigger based on the instruction; convert the first signal into a second signal, wherein the second signal is a frequency domain signal; perform a comparison of the trigger to the second signal; and process the second signal based on the comparison.

### CROSS-REFERENCE TO RELATED APPLICATIONS

This application claims priority to U.S. provisional application No. 62/194,002 filed Jul. 17, 2015 by Karl E. Moerder, et al., and titled “Capturing and Analyzing Hybrid Fiber Coaxial (HFC) System Transient Events,” which is incorporated by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Hybrid fiber-coaxial (HFC) networks are broadband networks that combine optical fibers and coaxial cables. Cable television (CATV) operators have deployed HFC networks since the early 1990s. When CATV operators operate multiple HFC networks, they are referred to as multi-system operators (MSOs). HFC networks typically employ frequency-division multiplexing (FDM), quadrature amplitude modulation (QAM), and other networking and modulation techniques to provide a variety of services, including television (TV), telephony, and Internet services. CableLabs Data Over Cable Service Interface Specification (DOCSIS) 3.1, which is a standard for MSOs, provides for Internet service at data rates between 1 gigabit per second (Gb/s) and 10 Gb/s.

### SUMMARY

In one embodiment, the disclosure includes a coaxial cable remote diagnostic management tool (RDMT) comprising: a receiver configured to: receive a first signal, wherein the first signal is a time domain signal; and receive an instruction to analyze the first signal; and a processor coupled to the receiver and configured to: generate a trigger based on the instruction; convert the first signal into a second signal, wherein the second signal is a frequency domain signal; perform a comparison of the trigger to the second signal; and process the second signal based on the comparison. In some embodiments, the processor is further configured to discard the second signal when the processor determines that the second signal does not comprise a transient event; the processor is further configured to retain the second signal when the processor determines that the second signal comprises a transient event; the receiver is further configured to receive a request for transient event data, and wherein the RDMT further comprises a transmitter configured to transmit the second signal in response to the request; the processor is further configured to retain a first pre-determined amount of pre-event data occurring before the transient event; the processor is further configured to retain a second pre-determined amount of post-event data occurring after the transient event; the processor is further configured to determine the first pre-determined amount and the second pre-determined amount based on a type of the transient event; the processor is further configured to generate tagged data associated with the first signal or the second signal; the tagged data comprise clock data; the processor is further configured to adjust the clock data based on a range offset associated with the RDMT; the tagged data comprise one of a tuned frequency, demodulation parameters, and an indication of which component in a cable network is expected to have transmitted the first signal; the trigger is one of a max-hold trigger, a frequency mask threshold trigger, a duration trigger, and a triggered arm trigger; the RDMT is configured to: couple to a hybrid fiber-coaxial (HFC) network via a reverse-direction tap (RDT); and monitor the HFC network for transient events.

In another embodiment, the disclosure includes an apparatus for use in a coaxial network, the apparatus comprising: a trigger generation component configured to: receive an instruction to generate a trigger for capturing a transient event; and generate the trigger in response to the instruction; a trigger application component coupled to the trigger application component and configured to: receive the trigger from the trigger generation component; compare a first signal to the trigger; discard the first signal upon determining that the first signal does not comprise the transient event; and retain the first signal upon determining that the first signal does comprise the transient event. In some embodiments, the apparatus further comprises a proactive network management (PNM) headend component configured to: couple to a diagnostic reverse (DR) port of a reverse-direction tap (RDT) located in the coaxial network; and receive, through the DR port, upstream signals originating in the coaxial network downstream from the RDT; and a PNM cable modem (CM) component coupled to the PNM headend component and configured to: couple to a diagnostic forward (DF) port of the RDT; and receive downstream signals originating in the coaxial network upstream from the RDT; a processing component coupled to the PNM headend component, the PNM CM component, and the trigger application component and configured to: receive a second signal from either the PNM headend component or the PNM CM component, wherein the second signal is a time domain signal; and perform a fast Fourier transform (FFT) on the second signal to produce the first signal, wherein the first signal is a frequency domain signal; a storage component coupled to the trigger application component and configured to: receive the first signal from the trigger application component; and store the first signal until further notification.

In yet another embodiment, a method comprises: receiving a plurality of time domain signals; converting the time domain signals into a plurality of frequency domain signals comprising a first signal and a second signal; determining that the first signal does not comprise a transient event; discarding the first signal in response to the determining; deciding that at least a first portion of the second signal comprises the transient event; and retaining the first portion in response to the deciding. In some embodiments, the method further comprises retaining a second portion of the second signal, wherein the second portion represents a pre-determined amount of the second signal occurring before the first portion; receiving clock data; generating tagged data comprising the clock data; and associating the clock data with the first portion and the second portion.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an HFC network.

FIG. 2 is a schematic diagram of an HFC network analyzing system according to an embodiment of the disclosure.

FIG. 3 is a schematic diagram of a remote diagnostic management tool (RDMT) in FIG. 2 according to an embodiment of the disclosure.

FIG. 4 is an illustration of a method for filtering processed data according to an embodiment of the disclosure.

FIG. 5 is a flowchart illustrating a method of adjusting tagged data according to an embodiment of the disclosure.

FIG. 6 is a schematic diagram illustrating time offsets in an HFC network comprising an integrated CMTS/CCAP according to an embodiment of the disclosure.

FIG. 7 is a schematic diagram illustrating time offsets in an HFC network comprising a distributed CMTS/CCAP according to an embodiment of the disclosure.

FIG. 8 is a schematic diagram illustrating time offsets in an HFC network comprising an embedded RDMT according to an embodiment of the disclosure.

FIG. 9 is a flowchart illustrating a method of filtering transient events according to an embodiment of the disclosure.

FIG. 10 is a schematic diagram of a network device according to an embodiment of the disclosure.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

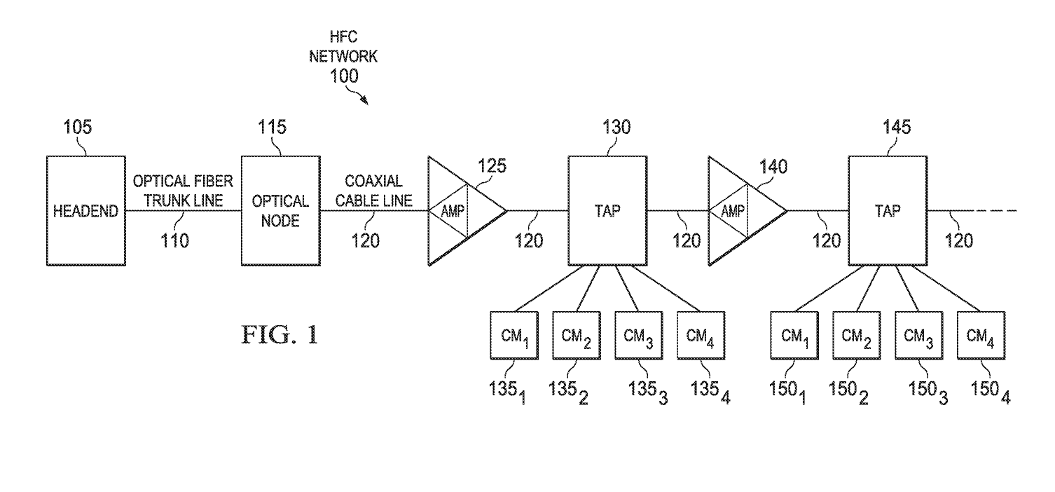

FIG. 1 is a schematic diagram of an HFC network 100. The network 100 is described in U.S. patent application Ser. No. 15/042,322 filed Feb. 12, 2016 by John L. Moran III, et al., and titled “Reverse-Direction Tap (RDT), Remote Diagnostic Management Tool (RDMT), and Analyses Using the RDT and the RDMT” (“Moran”), which is incorporated by reference. The network 100 generally comprises a headend 105; optical fiber trunk line 110; an optical node 115; a coaxial cable line 120; amplifiers (amps) 125, 140; taps 130, 145; and cable modems (CMs) 135, 150. The network 100 may employ DOCSIS 3.0 or DOCSIS 3.1, which are incorporated by reference, or other standard.

The headend 105 may be or may implement, for instance, a Converged Cable Access Platform (CCAP), a distributed CCAP (DCCAP), an integrated CCAP (ICCAP), a cable modem termination system (CMTS), a distributed CMTS (DCMTS), an integrated CMTS (ICMTS), a cable management system (CMS), a proactive network management (PNM) device, or any diagnostic equipment. The headend 105 provides multiple functions. First, the headend 105 communicates with the CMs 135, 150 via the optical node 115 using optical transmitters and receivers. Second, the headend 105 communicates with a backbone network such as the Internet using other optical transmitters and receivers. Third, the headend 105 therefore serves as an intermediary between the CMs 135, 150 on the one hand and the backbone network on the other hand. Fourth, the headend 105 schedules both downstream (DS) and upstream (US) communications. Downstream communications, or forward-path communications, refer to communications from the headend 105 to the CMs 135, 150. Upstream communications, which may also be referred to as return-path communications or reverse-path communications, refer to communications from the CMs 135, 150 to the headend 105.

The optical fiber trunk line 110 couples the headend 105 to the optical node 115. The optical fiber trunk line 110 may comprise an inner optical fiber that communicates optical signals and an outer insulating layer that protects the fiber from environmental and other conditions. The optical fiber trunk line 110 is typically many kilometers (km) long.

The optical node 115 may be referred to as an HFC node or a fiber node. The optical node 115 converts optical signals from the headend 105 into electrical signals and forwards those electrical signals to the CMs 135, 150. Similarly, the optical node 115 converts electrical signals from the CMs 135, 150 to optical signals and forwards those optical signals to the headend 105. The optical node 115 is located at the entrance of a subdivision or another location, for example.

The coaxial cable line 120 couples the optical node 115 to the amp 125, the amp 125 to a tap 130, the tap 130 to the CMs 135, the tap 130 to the amp 140, the amp 140 to the tap 145, and the tap 145 to the CMs 150. Alternatively, each described portion of the coaxial cable line 120 is a separate line. The coaxial cable line 120 may comprise four layers. The first, innermost layer is a copper core that communicates electrical signals in conjunction with the next two layers. The second layer is a dielectric insulator; the third layer is a metallic shield; and the fourth, outermost layer is a plastic jacket. The coaxial cable line 120 is typically less than 1 km long. The coaxial cable line 120 may be semi-rigid and may be referred to as hardline.

The amps 125, 140 amplify electrical signals in both the forward path and return path directions of the network 100, and the amps 125, 140 equalize electrical signals in the forward path direction of the network 100 to compensate for frequency roll-off, slope, which occurs as a result of the electrical signals traversing both the coaxial cable line 120 and the taps 130, 145. Equalization may also be referred to as positive tilt compensation, which comprises adding a sufficient amount of pre-emphasis to electrical signals in order to flatten a frequency response at the input of a subsequent component. The amps 125, 140 may receive alternating current (AC) power from the coaxial cable line 120 and therefore may not require their own power sources. The amps 125, 140 are located at any suitable locations. As shown by the ellipsis, there may be additional amps similar to the amps 125, 140. Furthermore, additional amps may be present at the customer premises.

The taps 130, 145 are coaxial cable taps and pass the coaxial cable line 120 from an input port to an output port and provide tap outputs for the CMs 135, 150 as described below. The taps 130, 145 are passive devices, meaning that they do not use powered electronic components such as amplifiers. While the tap 130 shows connections to the four CMs 135 and the tap 145 shows connections to the four CMs 150, the taps 130, 145 may connect to any number of CMs. The taps 130, 145 typically block the AC power from the coaxial cable line 120. The taps 130, 145 are located at the end of streets or other locations, for example. As shown by the ellipsis, there may be additional taps similar to the taps 130, 145.

The CMs 135, 150 provide multiple functions. First, the CMs 135, 150 communicate with the headend 105 via the optical node 115 using electrical transmitters and receivers. Second, the CMs 135, 150 communicate with subscriber devices using other electrical transmitters and receivers. Third, the CMs 135, 150 serve as intermediaries between the headend 105 on the one hand and the subscriber devices on the other hand. The subscriber devices include computers, TVs, or other Internet-enabled devices. When the CMs 135, 150 communicate with TVs, the CMs 135, 150 may be referred to as set-top boxes (STBs). The CMs 135, 150 are located at customer premises, for instance, at or in houses. Though four CMs 135 and four CMs 150 are shown, there may be fewer or more CMs 135, 150.

The network 100 may experience transient events, which are short-lived bursts of energy caused by a sudden change of state. Transient events include impulse noises, which are sudden spike-like transitions between two or more discrete voltage levels or current levels that occur at unpredictable times. Impulse noise may be caused by laser clipping; arcing from motors or lighting; orthogonal frequency-division multiplexing (OFDM) signals generated by Home Plug, Home Phoneline Networking Alliance (HomePNA), HomeGrid, or Multimedia over Coax Alliance (MoCA) equipment at a subscriber premise; intermittent coaxial cable connections; and external signal leakage into coaxial cables. Poor grounding, cracked or damaged cables, and loose or corroded connectors are often the causes of external signal leakage. Transient events include other events as well. Transient events degrade performance of the network 100. Thus, it is important to capture, recognize, and analyze those transient events in order to isolate them.

In the network 100, the headend 105 and the CMs 135, 150 perform capturing, recognizing, and analysis operations in both an online and an offline manner. Online may be used synonymously with real-time and refers generally to operations that are considered immediate from a user's perspective and refers specifically to operations that are quick enough to keep up with incoming data. Offline refers to operations that are saved for later analysis without time constraints. One approach for such operations is to continuously capture and store data online and then to analyze that data offline. However, that approach may require a large amount of memory for storing the data, and the large amount of memory is costly. Another approach is to capture data online, perform fast Fourier transforms (FFTs) on the data online, average the FFT data online over a period of time to reduce the amount of data for storage, and analyze the averaged FFT data offline. However, the averaging of the FFT data may reduce transient event detection sensitivity by, for example, about 20 decibels (dB).

Disclosed herein are embodiments for improved capture, recognition, storage, and analysis of transient events in an HFC network. The disclosed embodiments employ components at headends, CMs, taps, and other nodes to capture data, recognize transient events in the data, store the transient event data, and analyze the transient event data. First, the components recognize transient event data using various triggers that improve transient event detection sensitivity. Second, the components store primarily or only the transient event data, thus freeing hardware resources and allowing for storage of more transient event data.

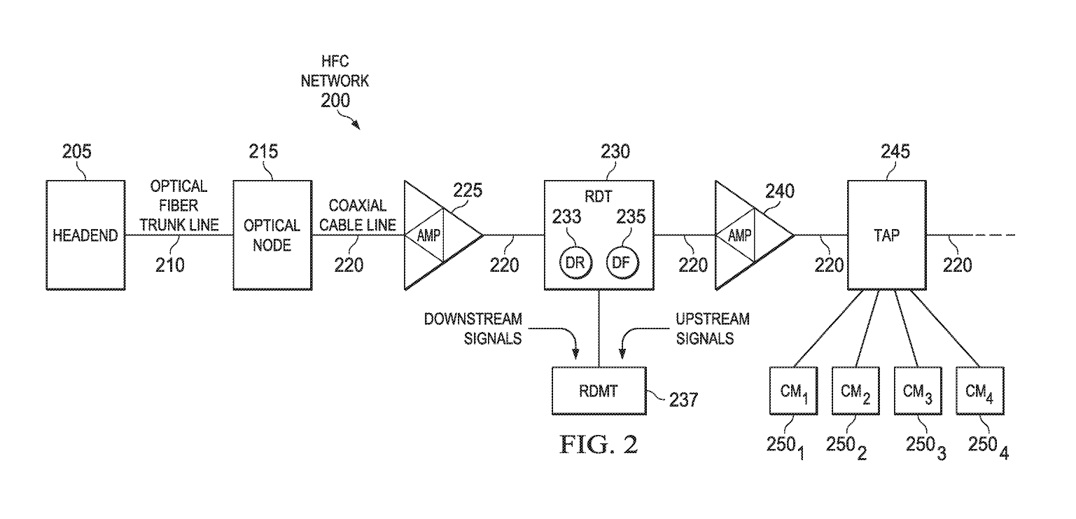

FIG. 2 is a schematic diagram of an HFC network analyzing system 200 according to an embodiment of the disclosure. The system 200 and its components are similar to the network 100 and its components. However, unlike the network 100, the system 200 comprises an RDT 230 in place of a tap such as the tap 130 and comprises an RDMT 237.

The RDT 230 is shown as comprising a diagnostic reverse (DR) port 233 and a diagnostic forward (DF) port 235. The DR port 233 and the DF port 235 provide for analyzing upstream signals and injecting downstream test signals. The DR port 233 and the DF port 235 may exclusively provide for such analyzing or may also provide regular signal paths to CMs such as the CMs 135. The DR port 233 receives upstream signals originating downstream from the RDT 230 at, for instance, the tap 245. The DR port 233 also injects downstream signals towards, for instance, the tap 245. The DF port 235 receives downstream signals originating upstream from the RDT 230 at, for instance, the headend 205. The DF port 235 also injects upstream signals towards, for instance, the headend 205. The DR port 233 and the DF port 235 are single ports in order to minimize through loss. In addition, the RDT 233 may comprise a bidirectional input port and a bidirectional output port for passing signals both upstream and downstream, as well as tap ports dedicated to passing signals to and from CMs such as the CMs 135.

The RDMT 237 is coupled to the RDT 230. The RDMT 237 receives upstream signals from the DR port 233 of the RDT 230 and receives downstream signals from the DF port 235 of the RDT 230. The RDMT 237 then performs various functions on those upstream signals and downstream signals as described further below. While the RDT 230 and the RDMT 237 are shown between the amp 225 and the amp 240, the RDT 230 and the RDMT 237 may be placed in any suitable location in the system 200. In other words, the RDT 230 and the RDMT 237 may be placed at any middlepoint in the system 200.

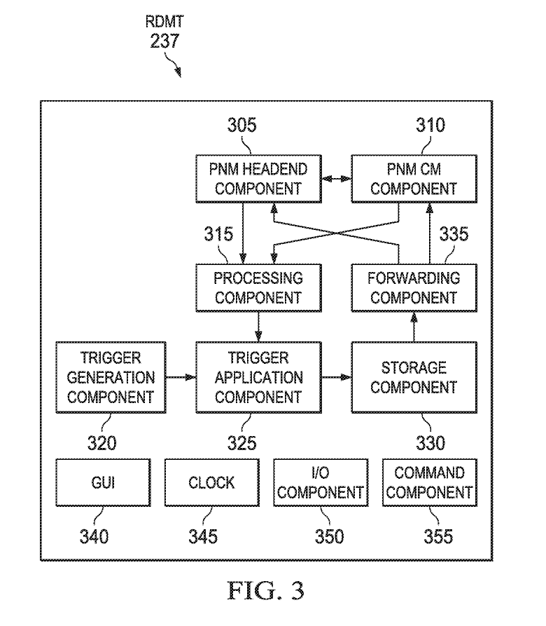

FIG. 3 is a schematic diagram of the RDMT 237 in FIG. 2 according to an embodiment of the disclosure. The RDMT 237 comprises a PNM headend component 305, a PNM cable modem (CM) component 310, a processing component 315, a trigger generation component 320, a trigger application component 325, a storage component 330, a forwarding component 335, a graphical user interface (GUI) 340, a clock 345, an input/output (I/O) component 350, and a command component 355. The components of the RDMT 237 may be arranged as shown or in any other suitable manner.

The PNM headend component 305 is coupled to the DR port 233 of the RDT 230 in FIG. 2, the PNM CM component 310, the processing component 315, and the forwarding component 335. The PNM headend component 305 receives, or captures, upstream signals originating downstream from the RDT 230, for instance at the CMs 250. The PNM headend component 305 then transmits those upstream signals to the processing component 315. The upstream signals may be continuous time domain signals for designated periods of time. In addition, the PNM headend component 305 receives data from the forwarding component 335 and transmits that data towards downstream components through the RDT 230.

The PNM CM component 310 is coupled to the DF port 235 of the RDT 230 in FIG. 2, the PNM headend component 305, the processing component 315, and the forwarding component 335. The PNM CM component 310 receives downstream signals originating upstream from the RDT 230, for instance at the headend 205. The PNM CM component 310 then transmits those downstream signals to the processing component 315. The signals may be continuous time domain signals for designated periods of time. Collectively, the upstream signals from the PNM headend component 305 and the downstream signals from the PNM CM component 310 may be referred to as raw signals or raw data. In addition, the PNM CM component 310 receives data from the forwarding component 335 and transmits that data towards upstream components through the RDT 230.

The processing component 315 is coupled to the PNM headend component 305, the PNM CM component 310, and the trigger application component 325. The processing component 315 receives upstream signals from the PNM headend component 305 and receives downstream signals from the PNM CM component 310. The processing component 315 processes those upstream signals and downstream signals and produces processed data or processed metrics such as FFT, slicer error ratio (SLERR), modulation error ratio (MER), equalizer coefficient, forward error correction (FEC), and other suitable data. SLERR refers to distances between soft decision metrics and hard decision metrics. The raw data and the processed data may be high-bandwidth data and therefore require significant memory resources for storage. The processing component 315 then transmits the processed data to the trigger application component 325.

The trigger generation component 320 is coupled to the trigger application component 325. The trigger generation component 320 receives instructions from the command component 355 to generate triggers for the RDMT 237 to capture transient events. Based on the nature of the desired transient events, the trigger generation component 320 generates triggers and transmits those triggers to the trigger application component 325. For instance, the triggers may be max-hold, frequency mask threshold, duration, and triggered arm triggers. Max-hold triggers refer to a highest value for data that repeat over time. Frequency mask threshold triggers refer to data that exceed a threshold within specified frequency ranges, or masks. Duration triggers refer to data that last for a specified period of time. Triggered arm triggers refer to specified network events such as ranging busts from particular network components. The triggers may also be peak sample powers; peak FFT bin powers in selected frequency bins; the total power above an expected power level, which may indicate interference; the total power below an expected power level, which may indicate missing signal components; peak-hold FFT data; received data errors in orthogonal frequency-division multiplexing (OFDM) sub-channels; poor correlation of phases and amplitudes of pilot sub-channels; incorrect relationships between pilot and data sub-channel amplitudes; changes in a MER, channel impulse response, or channel frequency response; and receive errors of DOCSIS 3.0 or earlier carriers.

The trigger application component 325 is coupled to the processing component 315, the trigger generation component 320, and the storage component 330. The trigger application component 325 receives the processed data from the processing component 315 and receives the triggers from the trigger generation component 320. The trigger application component 325 compares the processed data to the triggers and determines whether the processed data comprises transient events based on that comparison. When the trigger application component 325 determines that the processed data does not comprise transient events, then the trigger application component 325 discards the processed data. When the trigger application component 325 determines that the processed data does comprise transient events, then the trigger application component 325 retains the processed data as retained data.

In addition to the processed data associated with transient events, the trigger application component 325 may also retain processed data occurring before, after, or both before and after transient events. The data occurring before transient events may be referred to as pre-event data, and the data occurring after transient events may be referred to as post-event data. The trigger application component 325 determines an amount of pre-event data and an amount of post-event data to retain. The trigger application component 325 may determine the amounts based on the types of raw data, processed data, or transient events. If a trigger requires greater processing, then the trigger application component 325 may retain greater pre-event data and post-event data.

As an example, the trigger application component 325 receives from the processing component 315 five time domain signal samples that make up part or all of a processed signal. A first sample is from time t₁ to time t₂, a second sample is from time t₂ to time t₃, a third sample is from time t₃ to time t₄, a fourth sample is from time t₄ to time t₅, and a third sample is from time t₆ to time t₆. The trigger application component 325 determines that the third sample from time t₃ to time t₄ comprises a transient event. Thus, in addition to retaining the third sample from t₃ to time t₄, the trigger application component 325 retains the second sample from time t₂ to time t₃ and the fourth sample from t₄ to time t₅.

Furthermore, the trigger application component 325 generates tagged data and then associates the tagged data with, or tags tagged data to, the retained data. Generally, tagged data may be any data that provide context for later analyses. As such, the tagged data may also be referred to as metadata. Specifically, tagged data may comprise clock data, communication channels, types of bursts or transmissions, data that the trigger generation component 320 or another component commands to be tagged, or other suitable data corresponding to transient events. For instance, if the trigger generation component 320 commands the trigger application component 325 to retain processed data for a type of ranging burst from a specific component, then the tagged data may comprise the type of the ranging burst and data identifying the specific component. The tagged data may also comprise a tuned frequency, demodulation parameters such as a timing of and a phase of the raw signals, and an indication of which component of the system 200 is expected to have transmitted the data, all of which provide further analysis capabilities. Because the retained data is only a portion of the processed data, the retained data and their tagged data may be low-bandwidth data and therefore require relatively little or insignificant memory resources for storage.

The trigger application component 325 then transmits the retained data and the tagged data to the storage component 330. Alternatively, the trigger application component 325 then transmits the retained data and the tagged data to other components such as an external computer located at the headend 205 or a network operator center (NOC) for recognition of transient events. The retained data and tagged data allow a network operator or technician to, for instance, correlate occurrences of error bursts to transient events, locate loose and corroded connectors, and/or correlate upstream and downstream events. The network operator or the technician completes analyses of transient events online or offline. The network operator or the technician completes offline analyses at a later time, for example, from a few milliseconds to a few months after the occurrences of the transient events.

The storage component 330 is coupled to the trigger application component 325 and the forwarding component 335. The storage component 330 is, for instance, any suitable hardware memory or a portion of such memory. The storage component 330 receives the retained data and the tagged data and stores them until further notification. For instance, the command component 355 instructs the storage component 330 to transmit retained data and tagged data to the forwarding component 335 and discard the retained data and the tagged data thereafter.

The forwarding component 335 is coupled to the storage component 330, the PNM headend component 305, and the PNM CM component 310. The forwarding component 335 receives retained data and tagged data from the storage component 330 and receives instructions to forward the retained data and the tagged data either upstream or downstream. If instructed to forward the retained data and the tagged data upstream, the forwarding component 335 transmits the retained data and the tagged data to the PNM CM component 310 for further forwarding upstream. If instructed to forward the retained data and the tagged data downstream, the forwarding component 335 transmits the retained data and the tagged data to the PNM headend component 305 for further forwarding downstream. The forwarding component 335 receives the instructions from the command component 355, which generates the instructions in response to a schedule or a request from another component of the system 200 such as the headend 205.

The GUI 340 is coupled to the components of the RDMT 237 in any suitable manner. The GUI 340 displays icons and other visual indicators for a user to visualize so that the user can provide inputs to the I/O component 350. The clock 345 is coupled to the components of the RDMT 237 in any suitable manner. The clock 345 maintains an internal clock time for the RDMT 237, stores external clock times associated with various components of the system 200, and associates the internal clock times and the external clock times with each other. The I/O component 350 receives and processes inputs from the user and receives and processes outputs intended for the user.

Finally, the command component 355 is coupled to the components of the RDMT 237 in any suitable manner. The command component 355 commands the components of the RDMT 237 to perform their assigned functions. For instance, the command component 355 commands the processing component 315 when to process raw data and commands the trigger application component 325 to determine whether processed data comprises transient events. The command component 355 does so in response to any suitable events. The events include scheduled events based on internal clock times from the clock 345 or external clock times, the RDMT 237 receiving certain types of packets such as ranging packets, and detection of channel bonding in the system 200.

While the components of the RDMT 237 are described as performing specific functions, some components may perform the functions of other components as desired. In addition, all of the components are described in the context of the RDMT 237, but the components may exist in both the RDMT 237 and other devices. For instance, devices separate from the RDMT 237 may perform the functions of the storage component 330 and the forwarding component 335.

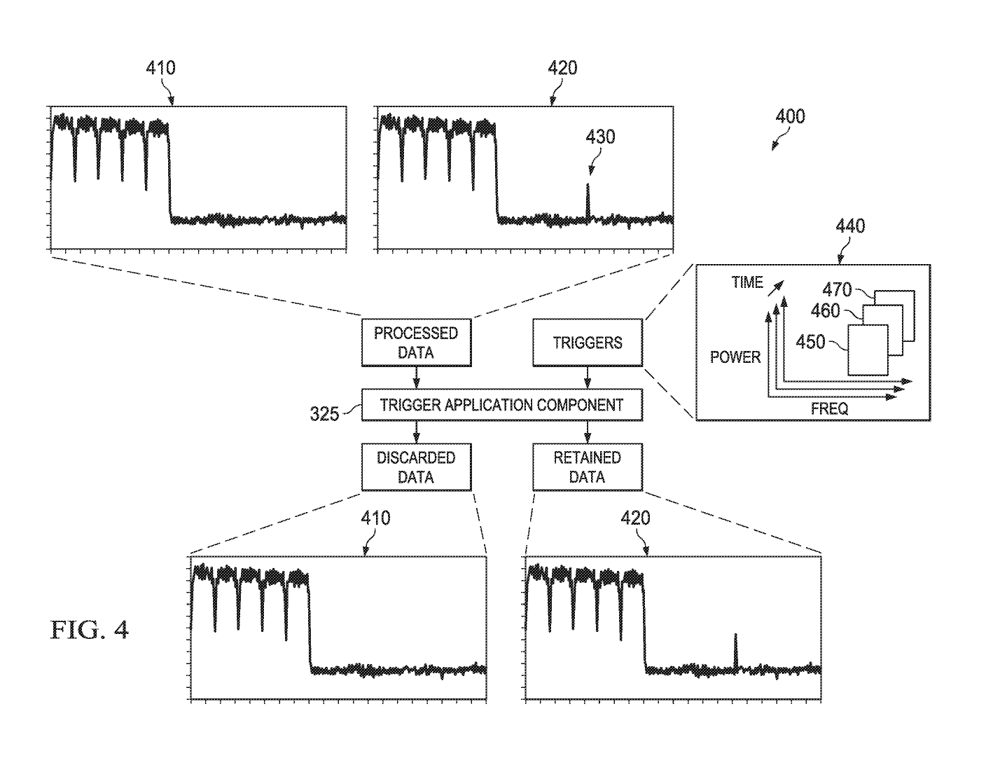

FIG. 4 is an illustration of a method 400 for filtering processed data according to an embodiment of the disclosure. The trigger application component 325 performs the method 400. First, the trigger application component 325 receives processed data from the processing component 315 and receives triggers 440 from the trigger generation component 320. The processed data comprise first processed data 410 and second processed data 420, which are represented as continuous data in power-versus-frequency spectra. The first processed data 410 represent data captured at a time t₁, and the second processed data 420 represents data captured at a time t₂. In this example, the triggers 440 comprise a first trigger 450, a second trigger 460, and a third trigger 470, which are represented as discrete portions in power-versus-frequency spectra. The first trigger 450 is associated with time t₁, the second trigger 460 is associated with time t₂, and the third trigger 470 is associated with time t₃. Thus, the first processed data 410 corresponds to the first trigger 450, the second processed data 420 corresponds to the second trigger 460, and no processed data shown corresponds to the third trigger 470.

Second, the trigger application component 325 compares the first processed data 410 to the first trigger 450. As shown, no portion of the first processed data 410 is present in the spectrum corresponding to the first trigger 450. Thus, the trigger application component 325 determines that the first processed data 410 comprises no transient events and discards the first processed data 410 as discarded data. The trigger application component 325 compares the second processed data 420 to the second trigger 460. As shown, a harmonic 430 of the second processed data 420 is present in the spectrum corresponding to the second trigger 460. Thus, the trigger application component 325 determines that the second processed data 420 comprises a transient event and retains the second processed data 420 as retained data. As mentioned above, the trigger application component 325 then transmits the retained data and tagged data to the storage component 330.

The establishment of a consistent time among the components of the network 100, including among the headend 105 and the CMs 135, 150, is important for transient event analyses. Each of the CMs 135, 150 comprises a local time based on its local clock. When the CMs 135, 150 register with the headend 105, the headend 105 and the CMs 135, 150 may employ ranging processes to determine range offsets between the headend 105 on the one hand and the CMs 135, 150 on the other hand. A range offset is a value indicating a round-trip delay between two points, in this case between the headend 105 on the one hand and the CMs 135, 150 on the other hand. The round-trip delay is the time it takes for a signal to travel from the headend 105 and to the CMs 135, 150 and back, or vice versa. Determining range offsets ensures that all upstream transmissions from the CMs 135, 150 to the headend 105 arrive at the headend 105 at designated time slots. In the DOCSIS standard, ranging may be performed based on range request (RNG-REQ) and range response (RNG-RSP) messages.

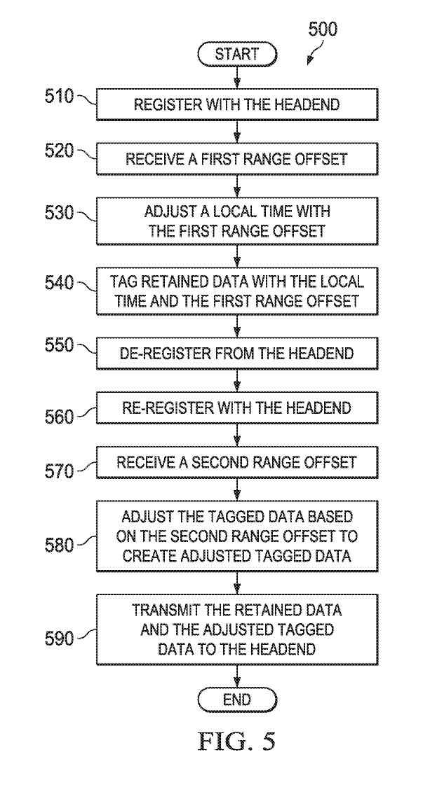

FIG. 5 is a flowchart illustrating a method 500 of adjusting tagged data according to an embodiment of the disclosure. One of the CMs 135, 150, specifically the CM 135₁, performs the method 500. At step 510, the CM 135₁ registers with the headend 105. At step 520, the CM 135₁ receives a first range offset from the headend 105. At step 530, the CM 135₁ adjusts a local time with the first range offset. The local time is associated with the CM 135₁. At step 540, the CM 135₁ tags retained data with the local time and the first range offset. At step 550, the CM 135₁ de-registers from the headend 105. The CM 135₁ does so by choice; in response to a command from the headend 105 or another component; or as a result of a loss of signal, timing, or power. At step 560, the CM 135₁ re-registers with the headend 105. However, upon re-registering, the local time of the CM 135₁ may change. Thus, the CM 135₁ needs to obtain a new range offset. At step 570, the CM 135₁ receives a second range offset. At step 580, the CM 135₁ adjusts the tagged data based on the second range offset to create adjusted tagged data. Finally, at step 590, the CM 135₁ transmits the retained data and the adjusted tagged data to the headend 105.

Because the CM 135₁ transmits to the headend 105 adjusted tagged data with the retained data, the CM 135₁ transmits data that have no timing errors caused by the change of the local time of the CM 135₁. The type of retained data being analyzed may dictate the resolution of the local times and the range offsets. In general, clock data with higher resolutions allow for analyses with higher sensitivities. In addition, the headend 105 may consider the locations of the CM 135₁ in the network 100 and the downstream timing acquisition errors of the CM 135₁ to further improve accuracy of the analyses.

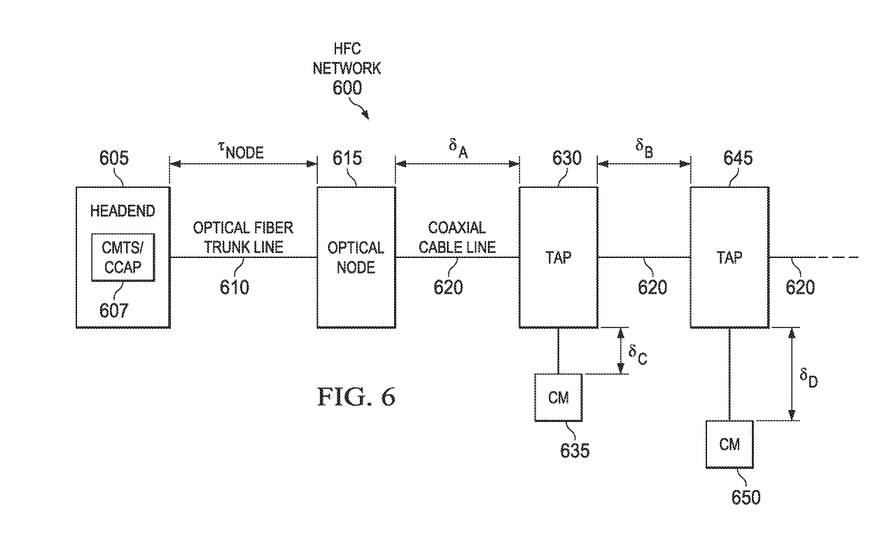

FIGS. 6-8 illustrate embodiments for obtaining time offsets in HFC networks that are similar to the network 100. However, some components in the HFC networks are different from the network 100 in order to demonstrate various offsets. In addition, for purposes of simplification, other components existing in the network 100 are not in the HFC networks.

FIG. 6 is a schematic diagram illustrating time offsets in an HFC network 600 comprising an integrated CMTS/CCAP according to an embodiment of the disclosure. The network 600 comprises a headend 605, an optical node 615 coupled to the headend 605 via an optical fiber trunk line 610, a tap 630 coupled to the optical node 615 via a coaxial cable line 620, a CM 635 coupled to the tap 630 via the via the coaxial cable line 620, a tap 645 coupled to the tap 630 via the coaxial cable line 620, and a CM 650 coupled to the tap 645 via the coaxial cable line 620. The components of the network 600 in FIG. 6 are similar to the components of the network 100 in FIG. 1. However, unlike the network 100, the network 600 comprises an integrated CMTS/CCAP 607 in the headend 605.

A time delay τ_{cm1} for a signal to travel from the headend 605 to the CM 635, and vice versa, is expressed as follows:

τ_{cm1}=τ_{node}+(δ_{A}/ν_{C})+(δ_{C}/ν_{C}), (1)

where τ_{node} is a time delay for an optical signal to travel from the headend 605 to the optical node 615 through the optical fiber trunk line 610 and vice versa, δ_{A} is a distance from the optical node 615 to the tap 630, v_{C} is a velocity of propagation in the coaxial cable line 620, and δ_{C} is a distance from the tap 630 to the CM 635. Similarly, a time delay τ_{cm2} for a signal to travel from the headend 605 to the CM 650, and vice versa, is expressed as follows:

τ_{cm2}=τ_{node}+(δ_{A}/ν_{C})+(δ_{B}/ν_{C})+(δ_{D}/ν_{C}), (2)

where δ_{B} is a distance from the tap 630 to the tap 645 and δ_{D} is a distance from the tap 645 to the CM 650.

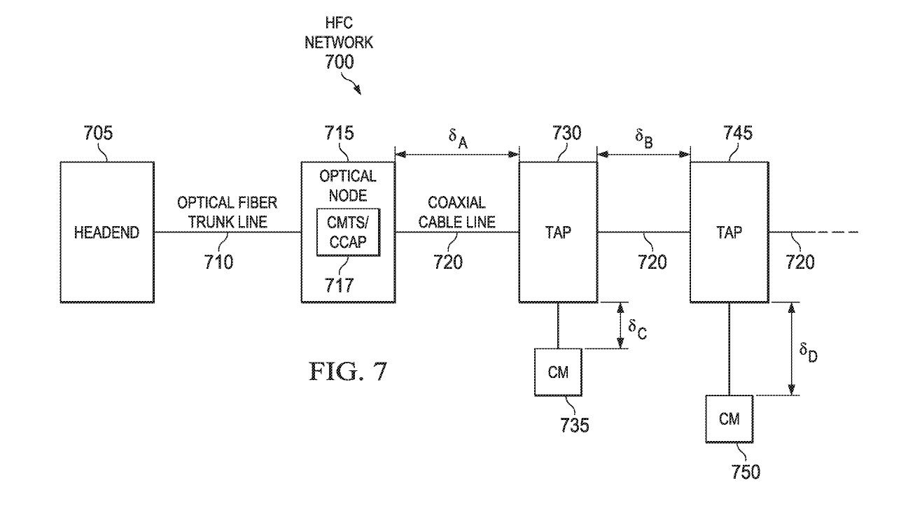

FIG. 7 is a schematic diagram illustrating time offsets in an HFC network 700 comprising a distributed CMTS/CCAP according to an embodiment of the disclosure. The network 700 is similar to the network 600 in FIG. 6. However, unlike in the network 600, the CMTS/CCAP 717 in the network 700 is in the optical node 715. τ_{cm1} and τ_{cm2} are expressed as follows:

τ_{cm1}=(δ_{A}/ν_{C})+(δ_{C}/ν_{C}) (3)

τ_{cm2}=(δ_{A}/ν_{C})+(δ_{B}/ν^{C})+(δ_{D}/ν_{C}). (4)

As can be seen, τ_{node}, and thus the optical fiber trunk line 710, do not affect either τ_{cm1} or τ_{cm2}.

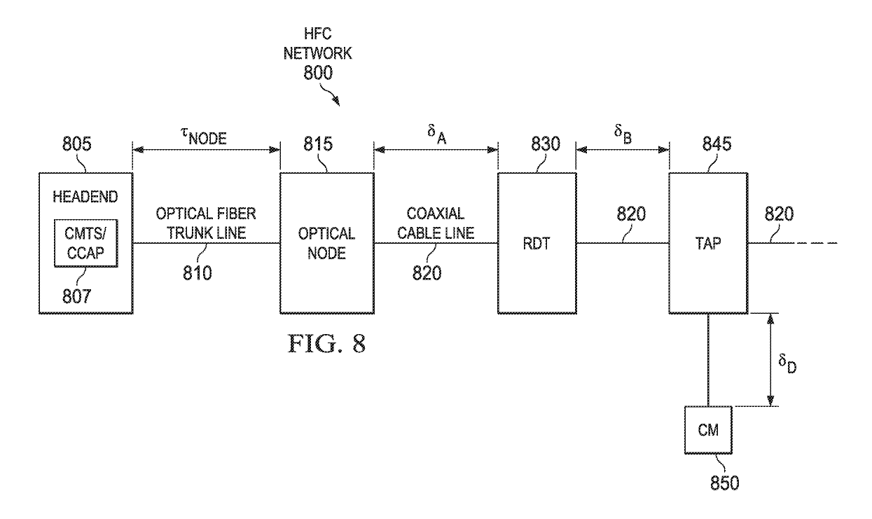

FIG. 8 is a schematic diagram illustrating time offsets in an HFC network 800 comprising an embedded RDMT according to an embodiment of the disclosure. The network 800 is similar to the network 600 in FIG. 6. However, the network 800 comprises an RDT 830 in place of the tap 630 and the CM 635 in the network 600. The RDT 830 is similar to the RDT 230 in the network 200 in FIG. 2.

A time delay τ_{RDT} for a signal to travel from the headend 805 to the RDT 830, and vice versa, is expressed as follows:

τ_{RDT}=τ_{node}+(δ_{A}/ν_{C}). (5)

A time delay τ_{cm} for a signal to travel from the headend 805 to the CM 850, and vice versa, is expressed as follows:

τ_{cm}=τ_{node}+(δ_{A}/ν_{C})+(δ_{B}/ν_{C})+(δ_{D}/ν_{C}). (6)

As shown, equation 6 is similar to equation 2. Finally, τ_{RDT,cm}, a time delay for a signal to travel from the RDT 830 to the CM 850, is expressed as follows:

τ_{RDT,cm}=(δ_{B}/ν_{C})+(δ_{D}/ν_{C})

τ_{RDT,cm}=τ_{cm}−τ_{RDT}. (7)

As shown by equation 8, τ_{RDT,cm} can be expressed as the difference between τ_{cm} and τ_{RDT}.

The time delays in equations 1-7 may be related to range offsets. For instance, for FIG. 6, τ_{cm1} in equation 1 may be expressed as follows:

$${τ}_{cm 1} = \frac{{RO}_{cm 1}}{2} \pm ( range uncertainty ) , \qquad ( 8 )$$

where RO_{cm1} is a range offset between the headend 605 and the CM 635 and range uncertainty is a time due to variations in an initial time synchronization of a component or, in this case, the CM 635. Similarly for FIG. 6, τ_{cm2} in equation 2 may be expressed as follows:

$${τ}_{cm 2} = \frac{{RO}_{cm 2}}{2} \pm ( range uncertainty ) , \qquad ( 9 )$$

where RO_{cm2} is a range offset between the headend 605 and the CM 650. As can be seen from equations 8 and 9, a range offset includes a round-trip delay between two components, in this case between the headend 605 on one hand and the CMs 635, 650 on the other hand. If the range uncertainty in equations 8 and 9 can be eliminated, then a technician need not determine locations of the CMs 635, 650.

As shown above, a technician may evaluate networks such as the networks 600, 700, 800 to determine time delays and range offsets for various components such as CMs. Subsequently, the technician may combine data captured by the CMs and employ the calculated time delays and range offsets to perform further analyses. By doing so, the technician may locate ingress noise sources in the networks.

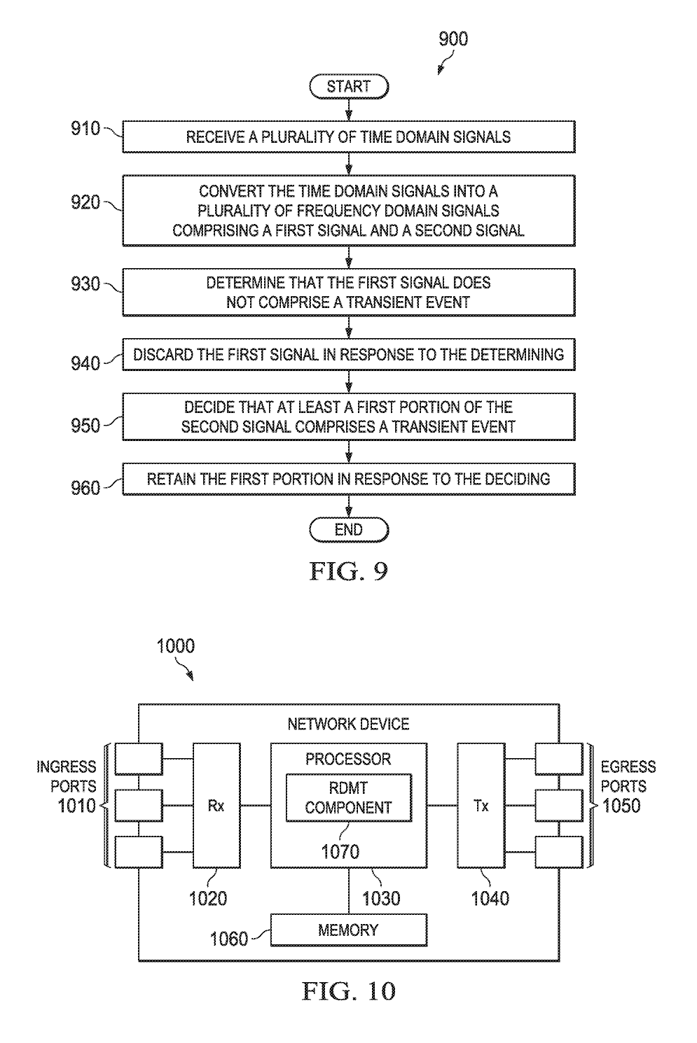

FIG. 9 is a flowchart illustrating a method 900 of filtering transient events according to an embodiment of the disclosure. The RDMT 237 may implement the method 900 in response to any suitable events such as scheduled events based on internal clock times from the clock 345 or external clock times, the RDMT 237 receiving certain types of packets such as ranging packets, and detection of channel bonding in the system 200. At step 910, a plurality of time domain signals is received. For instance, either the PNM headend component 305 or the PNM CM component 310 receives the time domain signals. At step 920, the time domain signals are converted into a plurality of frequency domain signals comprising a first signal and a second signal. For instance, the processing component 315 converts the time domain signals. At step 930, it is determined that the first signal does not comprise a transient event. For instance, the trigger application component 325 determines that the first signal does not comprise a transient event. At step 940, the first signal is discarded in response to the determining. For instance, the trigger application component 325 discards the first signal. At step 950, it is decided that at least a first portion of the second signal comprises a transient event. For instance, the trigger application component 325 decides that at least a first portion of the second signal comprises a transient event. Finally, at step 960, the first portion is retained in response to the deciding. For instance, the trigger application component 325 retains the first portion in response to the deciding.

FIG. 10 is a schematic diagram of a network device 1000 according to an embodiment of the disclosure. The device 1000 is suitable for implementing the disclosed embodiments. The device 1000 comprises ingress ports 1010 and receiver units (Rx) 1020 for receiving data; a processor, logic unit, or central processing unit (CPU) 1030 to process the data; transmitter units (Tx) 1040 and egress ports 1050 for transmitting the data; and a memory 1060 for storing the data. The device 1000 may also comprise optical-to-electrical (OE) components and electrical-to-optical (EO) components coupled to the ingress ports 1010, the receiver units 1020, the transmitter units 1040, and the egress ports 1050 for egress or ingress of optical or electrical signals.

The processor 1030 is implemented by hardware and software. The processor 1030 may be implemented as one or more CPU chips, cores (e.g., as a multi-core processor), field-programmable gate arrays (FPGAs), application specific integrated circuits (ASICs), and digital signal processors (DSPs). The processor 1030 is in communication with the ingress ports 1010, receiver units 1020, transmitter units 1040, egress ports 1050, and memory 1060. The processor 1030 comprises an RDMT component 1070. The RDMT component 1070 implements the disclosed embodiments described above. For instance, the RDMT component 1070 implements the RDMT 237. The inclusion of the RDMT component 1070 therefore provides a substantial improvement to the functionality of the device 1000 and effects a transformation of the device 1000 to a different state. Alternatively, the RDMT component 1070 is implemented as instructions stored in the memory 1060 and executed by the processor 1030.

The memory 1060 comprises one or more disks, tape drives, and solid-state drives and may be used as an over-flow data storage device, to store programs when such programs are selected for execution, and to store instructions and data that are read during program execution. The memory 1060 may be volatile and non-volatile and may be read-only memory (ROM), random-access memory (RAM), ternary content-addressable memory (TCAM), and static random-access memory (SRAM).

The use of the term “about” means a range including ±10% of the subsequent number, unless otherwise stated. While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

1. A coaxial cable remote diagnostic management tool (RDMT) comprising:
a receiver configured to:
receive a first signal, wherein the first signal is a time domain signal; and
receive an instruction to analyze the first signal; and
a processor coupled to the receiver and configured to:
generate a trigger based on the instruction;
convert the first signal into a second signal, wherein the second signal is a frequency domain signal;
perform a comparison of the trigger to the second signal; and
process the second signal based on the comparison.

2. The RDMT of claim 1, wherein the processor is further configured to discard the second signal when the processor determines that the second signal does not comprise a transient event.

3. The RDMT of claim 1, wherein the processor is further configured to retain the second signal when the processor determines that the second signal comprises a transient event.

4. The RDMT of claim 3, wherein the receiver is further configured to receive a request for transient event data, and wherein the RDMT further comprises a transmitter configured to transmit the second signal in response to the request.

5. The RDMT of claim 3, wherein the processor is further configured to retain a first pre-determined amount of pre-event data occurring before the transient event.

6. The RDMT of claim 5, wherein the processor is further configured to retain a second pre-determined amount of post-event data occurring after the transient event.

7. The RDMT of claim 6, wherein the processor is further configured to determine the first pre-determined amount and the second pre-determined amount based on a type of the transient event.

8. The RDMT of claim 1, wherein the processor is further configured to generate tagged data associated with the first signal or the second signal.

9. The RDMT of claim 8, wherein the tagged data comprise clock data.

10. The RDMT of claim 9, wherein the processor is further configured to adjust the clock data based on a range offset associated with the RDMT.

11. The RDMT of claim 10, wherein the tagged data comprise one of a tuned frequency, demodulation parameters, or an indication of which component in a cable network is expected to have transmitted the first signal.

12. The RDMT of claim 1, wherein the trigger is one of a max-hold trigger, a frequency mask threshold trigger, a duration trigger, and a triggered arm trigger.

13. The RDMT of claim 1, wherein the RDMT is configured to:
couple to a hybrid fiber-coaxial (HFC) network via a reverse-direction tap (RDT); and
monitor the HFC network for transient events.

14. An apparatus for use in a coaxial network, the apparatus comprising:
a trigger generation component configured to:
receive an instruction to generate a trigger for capturing a transient event; and
generate the trigger in response to the instruction;
a trigger application component coupled to the trigger generation component and configured to:
receive the trigger from the trigger generation component;
compare a first signal to the trigger; and
discard the first signal upon determining that the first signal does not comprise the transient event or retain the first signal upon determining that the first signal does comprise the transient event.

15. The apparatus of claim 14, further comprising:
a proactive network management (PNM) headend component configured to:
couple to a diagnostic reverse (DR) port of a reverse-direction tap (RDT) located in the coaxial network; and
receive, through the DR port, upstream signals originating in the coaxial network downstream from the RDT; and
a PNM cable modem (CM) component coupled to the PNM headend component and configured to:
couple to a diagnostic forward (DF) port of the RDT; and
receive downstream signals originating in the coaxial network upstream from the RDT.

16. The apparatus of claim 15, further comprising a processing component coupled to the PNM headend component, the PNM CM component, and the trigger application component and configured to:
receive a second signal from either the PNM headend component or the PNM CM component, wherein the second signal is a time domain signal; and
perform a fast Fourier transform (FFT) on the second signal to produce the first signal, wherein the first signal is a frequency domain signal.

17. The apparatus of claim 16, further comprising a storage component coupled to the trigger application component and configured to:
receive the first signal from the trigger application component; and
store the first signal until further notification.

18. A method comprising:
receiving a plurality of time domain signals;
converting the time domain signals into a plurality of frequency domain signals comprising a first signal and a second signal;
determining that the first signal does not comprise a transient event;
discarding the first signal in response to the determining;
deciding that at least a first portion of the second signal comprises the transient event; and
retaining the first portion in response to the deciding.

19. The method of claim 18, further comprising retaining a second portion of the second signal, wherein the second portion represents a pre-determined amount of the second signal occurring before the first portion.

20. The method of claim 19, further comprising:
receiving clock data;
generating tagged data comprising the clock data; and
associating the clock data with the first portion and the second portion.
